(19) United States
(12) Patent Application Publication
(10) Pub. No.: US 2009/0271557 A1
(43) Pub. Date: Oct. 29, 2009

(54) Non-volatile memory storage device with high transmission rate

(76) Inventor: Yulin Hsu, Hsin-Chu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 12/078,542

(22) Filed: Apr. 1, 2008

(30) Foreign Application Priority Data
Jan. 4, 2008 (TW) 097100316

(51) Int. Cl. G06F 13/36; G06F 12/00; G06F 12/02

(52) U.S. Cl. 710/315; 711/103; 711/E12.001; 711/E12.008

(57) ABSTRACT

A non-volatile memory storage device with a virtual USB host controller and a PCIe transmission interface is disclosed. The non-volatile memory storage device is a USB client device, although data access from a host apparatus is conducted by the PCIe interface. The virtual USB host controller comprising: a set of Registers, a Finite State Machine and a virtual USB wrapper implements a high speed storage device with USB client device through the PCIe interface.

### BACKGROUND OF THE INVENTION

1. Field of the Invention

This invention relates to a non-volatile memory storage device and, more particularly, to a non-volatile memory storage device whose data transmission with host is conducted by a Peripheral Component Interconnect express (PCIe) interface and client device is Universal Serial Bus (USB) client device for a higher transmission rate.

2. Description of the Prior Art

Data transportation follows some protocols for correct interconnection between different units or devices. With more and more advanced data processing rate of data access devices, protocols have to be upgraded too for higher and higher transmission rate. For example, Universal Serial Bus (USB) protocol has been upgraded to USB2.0 with higher transmission rate than USB1.1 and Peripheral Component Interconnect (PCI) protocol has been upgraded to PCI express (PCIe) with an even higher transmission rate than USB2.0.

A framework for conventional USB non-volatile memory storage device is shown in FIG. 4. A controller a coupled to a host apparatus a1 through an adapted USB connector controls data access on a non-volatile memory unit a5. A USB physical layer a2 in the front-end of controller a processes signal interconnected between the device and the host apparatus. A USB control unit a3 assigns the data access (reading event or writing event) on the non-volatile memory unit a5.

A framework of conventional PCIe client device with a controller b coupled to a host apparatus b1 is shown in FIG. 5. A PCIe physical layer b2 in the front-end of controller b processes signal interconnected between the device and the host apparatus. Then, a PCIe engine B3 processes host instructions on the peripheral components b4 such as network card, TV card and etc. . . .

The transmission rate for USB2.0 can be up to 480 Mbps. It is much higher than USB1.1. On the other hand, the transmission rate for PCIe can be up to 2.5 Gbps which is ascribed to her Dual-Simplex transmission mode (each channel pair comprising RX and TX). The PCIe protocol performs an outstanding and attractive transmission rate. However, client devices according to PCIe protocol are still very limited because it requires accompanied drivers which are not easy to be acquired in most host apparatus. PCIe is worked on a local bus as well as the other PCI systems. Different PCIe client devices need their bus drivers for communication. On the other hand, USB client devices are easy to be used in a variety of peripheral components. The USB host controller is built in most host apparatus. USB device is therefore a model for plug-play device.

Although ExpressCard using serial bus instead of PCMCI card (PC card) using parallel bus has integrated the two serial buses, USB2.0 and PCIe, their transmission channels are separate. ExpressCard provides a platform to build high efficiency module for device designers through its PCIe interface and also provides a connection for variable USB device through its USB2.0 interface respectively. Because the USB2.0 and PCIe channel in ExpressCard are independent, it still has to install an accompanied driver before using a PCIe peripheral component. ExpressCard can not support the variable and popular USB devices to connect with the host apparatus through its PCIe interface for the higher transmission rate.

### SUMMARY OF THE INVENTION

An object of this invention is providing a high speed storage device with the facility of USB storage device. Thus, a non-volatile memory storage device with a USB client controller and a PCIe interface for interconnection with a host apparatus is disclosed in the present invention. For data conversion between these two different protocols, a virtual USB host controller is coupled to the PCIe interface and a USB client controller.

Another object of this invention is providing a non-volatile memory storage device with high transmission rate for both PCIe and USB connector. Thus, a USB interface coupled to the host apparatus is operable to be adapted to the non-volatile memory storage device. A switching circuit between the PCIe and USB interface is needed for switching between PCIe and USB connector.

The basic framework for the non-volatile memory storage device in the present invention consists of a controller and one or a plurality of non-volatile memory units, wherein the controller comprises a PCIe Physical (PHY) layer, a PCIe engine, a virtual USB host controller, a USB client controller and a non-volatile memory controller. The PCIe PHY layer in the front-end of controller processes signal interconnected between the device and the host apparatus. The PCIe engine is coupled to the PCIe PHY layer. And, the virtual USB host controller coupled to the PCIe engine comprises: a Set of Registers (Register), a Finite State Machine (FSM) and a virtual USB wrapper. The FSM can output a status to the virtual USB wrapper in order to convert data from the PCIe engine to the USB client controller. The FSM outputs the status according to status passed from the Register which is controlled by a USB software. Then, the USB client controller can process data access from the host apparatus on the one or a plurality of non-volatile memory units through the non-volatile memory controller.

In one of embodiment, a USB PHY layer and a switch module are adapted too. The USB PHY layer in the front-end of controller processes signal interconnected between the device and the host apparatus. The USB PHY layer also comprises a USB interface detection unit for sending reset signal to the host apparatus automatically. When the reset signal detects the USB PHY layer has mounted on the host apparatus, the switch module switches to a coupling between the USB PHY layer and the USB client controller for processing data access through USB interface.

Additionally, the PCIe PHY layer also comprises a PCIe interface detection unit for sending reset signal to the host apparatus automatically. When the reset signal detects the PCIe PHY layer has mounted on the host apparatus, the switch module switches to a coupling between the PCIe PHY layer, the PCIe engine, virtual USB host controller and the USB client controller for processing data access through PCIe interface. The USB client controller can be coupled to the host apparatus through PCIe interface or USB interface automatically.

For a more complete understanding of the features and advantages of the present invention, reference is now made to the following description taken in conjunction with accompanying drawings, in which:

### BRIEF DESCRIPTION OF THE DRAWINGS

FIG. 1 shows block diagram for the first embodiment in the present invention.

FIG. 2 shows block diagram for the second embodiment in the present invention.

FIG. 3 shows block diagram for the third embodiment in the present invention.

FIG. 4 shows block diagram for the conventional USB2.0 storage device.

FIG. 5 shows block diagram for the conventional PCIe client device.

### DETAILED DESCRIPTION OF THE PREFERRED EMBODIMENTS

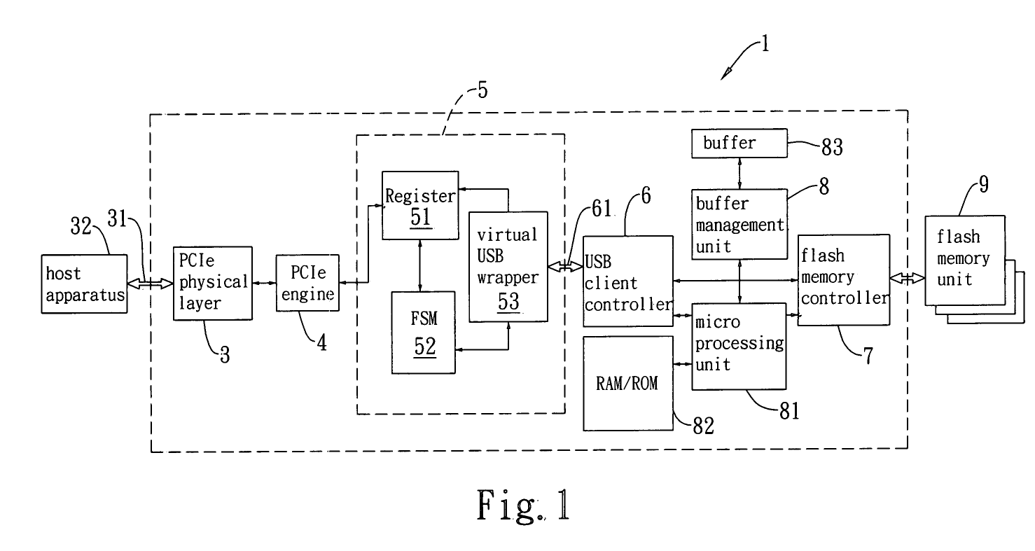

The first embodiment of non-volatile memory storage device with high transmission rate in the present invention is shown in FIG. 1. The non-volatile memory storage device 1 with a controller 2 and one or a plurality of non-volatile memory units 9 comprises: a PCIe physical layer 3, a PCIe engine 4, a virtual USB host controller 5, a USB client controller 6, a non-volatile memory controller 7, a buffer management unit 8, a micro processing unit 81 and a Random Access Memory/Read Only Memory (RAM/ROM).

The PCIe physical layer 3 builds electrical and mechanical connection with a host apparatus 32 though a PCIe connector 31 for processing signal interconnected between the device and the host apparatus. The PCIe engine 4 coupled to the PCIe physical layer 3 provides a logic circuit which is required for PCIe's data transmission.

The virtual USB host controller 5 coupled to the PCIe engine 4 comprises: a Set of Registers (Register) 51, a Finite State Machine (FSM) 52 and a virtual USB wrapper 53. The FSM 52 can output a status for the virtual USB wrapper 53 to convert data transmission between the PCIe engine and the USB client controller 6 through the Register 51. The FSM 52 outputs the status according to status passed from the Register 51 which is controlled by a USB software.

The USB client controller 6 is coupled to the virtual USB wrapper 53 through a virtual USB connector 61 for data transmission with the PCIe engine 4.

The non-volatile memory controller 7 is coupled to the USB client controller 6 and the non-volatile memory units 9 for data access from the host apparatus 32. The buffer management unit 8 is coupled to a buffer 83, the USB client controller 6 and the non-volatile memory controller 7 to provide a temporary data storage during execution of data access on the non-volatile memory units 9. The task assignment between the USB client controller 6, the buffer management unit 8 and the non-volatile memory controller 7 is controlled by the micro processing unit 81 with the RAM/ROM 82 for event of read access or write access.

For an event of read access or write access, data access instruction, address and data signal are sent to the PCIe physical layer 3 from the host apparatus 32. Through the PCIe engine 4 and the virtual USB host controller 5, transmission data between PCIe protocol and USB protocol can be converted and processed by the USB client controller 6. Then, the USB client controller 6 assigns tasks for data access to the non-volatile memory controller 7 to execute the event of read access or write access on the non-volatile memory units 9 according to the given address.

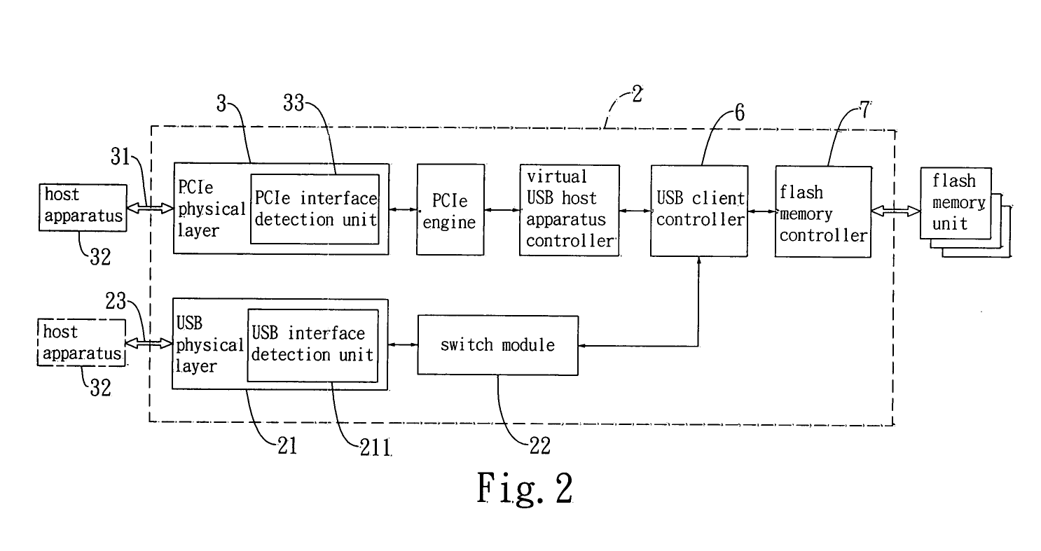

The second embodiment of the present invention is shown in FIG. 2. The controller 2 also consists of a USB physical layer 21 and a switch module 22.

The USB physical layer 21 is coupled electrically and mechanically to the host apparatus 32 through a USB connector 23 for USB data transmission. The USB physical layer 21 also comprises a USB interface detection unit 211. The switch module 22 is coupled to the USB physical layer 21 and USB client controller 6.

The USB interface detection unit 211 can send a reset signal automatically to the host apparatus 32 for sure of the mounting. When the USB interface detection unit 211 detects the USB physical layer 21 is mounted on the host apparatus 32, the switch module is operated to couple the USB physical layer 21 and the USB client controller 6. Then, data access from the host apparatus 32 can be operated by the USB client controller 6 and the non-volatile memory 7 through the USB interface.

Additionally, the PCIe physical layer 3 is operable to comprise a PCIe interface detection unit 33 for sending a reset signal to the host apparatus 32. Therefore, the USB client controller 6 and the non-volatile memory controller 7 can operate data access on the non-volatile memory units 9 through PCIe interface or USB interface.

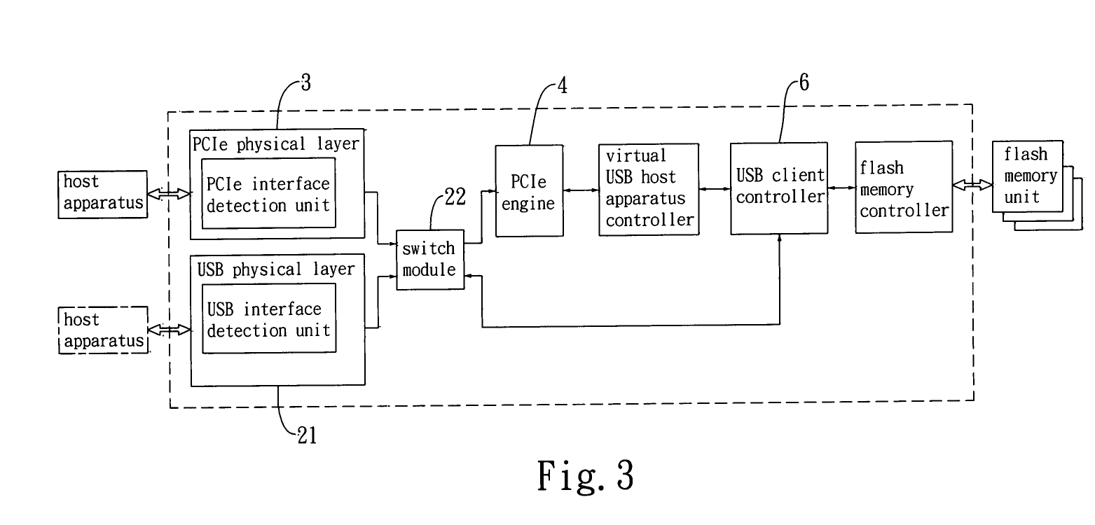

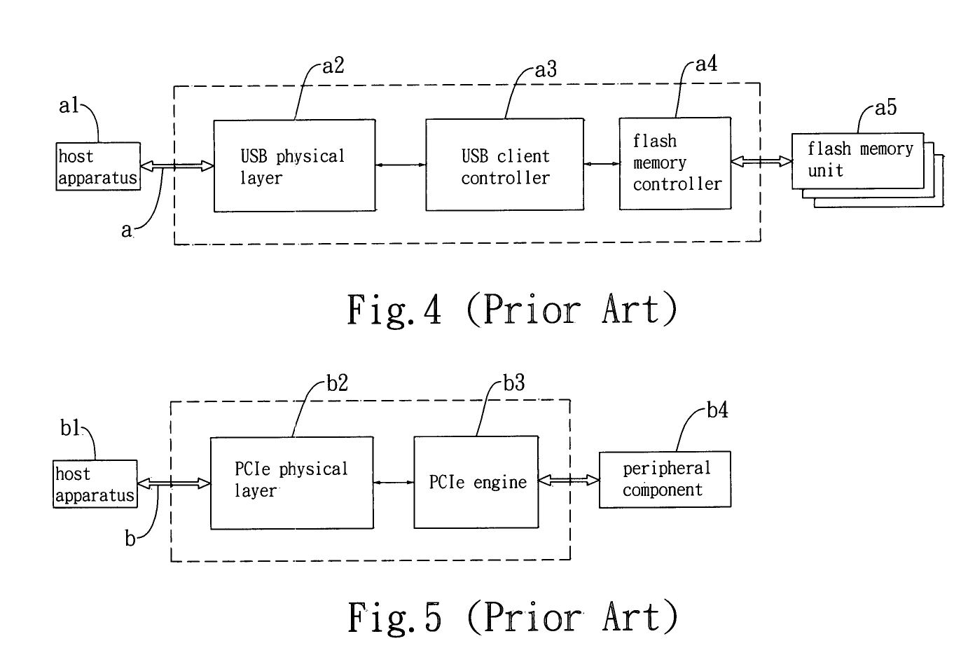

FIG. 3 shows block diagram for the third embodiment in the present invention. The switch module 22 has a switching circuit for coupling between the PCIe physical layer 3 and the PCIe engine 4, and coupling between the USB physical layer 21 and the USB client controller 6. The USB client controller 6 and the non-volatile memory controller 7 can be therefore operated through PCIe interface or USB interface by auto detection.

The non-volatile memory storage device disclosed in the present invention has the following advantages:
a) upgrading the transmission rate of USB client device through PCIe protocol without PCIe driver installation; and
b) switching between PCIe interface with 2.5 Gpbs and USB interface with 480 Mpbs by auto detection for different usages.

Accordingly, the non-volatile memory storage device disclosed in the present invention has a higher transmission rate to a host apparatus for data access on a USB client storage device. The present invention provides a high speed non-volatile memory storage device for industrial applications.

It should be understood that different modifications and variations could be made from the disclosures of the present invention by the people familiar in the art, which should be deemed without departing the spirit of the present invention.

What is claimed is:

1. A non-volatile memory storage device with high transmission rate comprises a controller and one or a plurality of non-volatile memory units, wherein the controller comprises:
(a) a Peripheral Component Interconnect express (PCIe) physical layer which is electrically and mechanically coupled to a host apparatus for data access;
(b) a PCIe engine which is coupled to the PCIe physical layer;
(c) a virtual Universal Serial Bus (USB) host controller which is coupled to the PCIe engine and comprises: a Set of Registers (Register), a Finite State Machine (FSM) and a virtual USB wrapper in order to convert data transmission between PCIe protocol and USB protocol;
(d) a USB client controller which is coupled to the virtual USB wrapper in order to execute the data access from host apparatus through the PCIe engine; and
(e) a non-volatile memory controller which is coupled to the USB client controller and the one or a plurality of non-volatile memory units in order to assign an event of read access or write access on the non-volatile memory units.

2. A non-volatile memory storage device according to claim 1, wherein the PCIe engine provides a logic circuit which is required for data transmission in PCIe protocol.

3. A non-volatile memory storage device according to claim 1, wherein the Register is controlled by a USB software for sending input or current status to the FSM; the FSM outputs an output status to the virtual USB wrapper according to the input and current status from Register; and the virtual USB wrapper converts instructions and data from the PCIe engine to the USB client controller, and vice versa.

4. A non-volatile memory storage device according to claim 1, wherein the USB client controller and the virtual USB wrapper are coupled.

5. A non-volatile memory storage device with high transmission rate according to claim 1 further comprises: a buffer management unit, a micro processing unit and a Random Access Memory/Read Only Memory (RAM/ROM), wherein the buffer management unit is coupled to the USB client controller and the non-volatile memory controller to manage a buffer during data access on the non-volatile memory units; the micro processing unit is coupled to the USB client controller, the non-volatile memory controller, the buffer management unit and the RAM/ROM to control read access or write access on the non-volatile memory units.

6. A non-volatile memory storage device with high transmission rate according to claim 4 further comprises: a buffer management unit, a micro processing unit and a Random Access Memory/Read Only Memory (RAM/ROM), wherein the buffer management unit is coupled to the USB client controller and the non-volatile memory controller to manage a buffer during data access on the non-volatile memory units; the micro processing unit is coupled to the USB client controller, the non-volatile memory controller, the buffer management unit and the RAM/ROM to control read access or write access on the non-volatile memory units.

7. A non-volatile memory storage device according to claim 1, wherein the type of the non-volatile memory can be the flash memory, the magnetic recording media, the phase-changed random access memory (PC-RAM), or any of the combinations.

8. A non-volatile memory storage device with high transmission rate comprises a controller and one or a plurality of non-volatile memory units, wherein the controller comprises:
(a) a Peripheral Component Interconnect express (PCIe) physical layer which is electrically and mechanically coupled to a host apparatus for data access;
(b) a PCIe engine which is coupled to the PCIe physical layer;
(c) a virtual Universal Serial Bus (USB) host controller which is coupled to the PCIe engine and comprises: a Set of Registers (Register), a Finite State Machine (FSM) and a virtual USB wrapper in order to convert data transmission between PCIe protocol and USB protocol;
(d) a USB client controller which is coupled to the virtual USB wrapper in order to execute the data access from host apparatus through the PCIe engine;
(e) a non-volatile memory controller which is coupled to the USB client controller and the one or a plurality of non-volatile memory units in order to assign an event of read access or write access on the non-volatile memory units;
(f) a USB physical layer which is electrically and mechanically coupled to a host apparatus for data access and comprises a USB interface detection unit in order to detect a connected channel between the USB physical layer and the host apparatus through sending a reset signal to the host apparatus automatically; and
(g) a switch module which is coupled to the USB physical layer and USB client controller in order to switch on the coupling between the USB physical layer and USB client controller as the USB interface detection unit detecting the channel to the host apparatus.

9. A non-volatile memory storage device with high transmission rate according to claim 8, wherein the PCIe physical layer further comprises: a PCIe interface detection unit in order to detect a connected channel between the PCIe physical layer and the host apparatus through sending a reset signal to the host apparatus automatically.

10. A non-volatile memory storage device with high transmission rate according to claim 8, wherein the switch module is coupled to the PCIe physical layer, the USB physical layer, the PCIe engine and the USB client controller in order to switch on the coupling between the PCIe physical layer and the PCIe engine for PCIe interface transmission and to switch on the coupling between the USB physical layer and the USB client controller for USB interface transmission.

11. A non-volatile memory storage device according to claim 8, wherein the type of the non-volatile memory can be the flash memory, the magnetic recording media, the phase-changed random access memory (PC-RAM), or any of the combinations.
